(19) United States
(12) Patent Application Publication
(10) Pub. No.: US 2012/0231691 A1
(43) Pub. Date: Sep. 13, 2012

(54) Porous Multilayer Articles and Methods of Making

(76) Inventors: Jeremie Peyras-Carratte, Sainte Maxence (FR); Jean-Marie Coant, Saint-Denis (FR)

(21) Appl. No.: 13/503,539

(22) PCT Filed: Oct. 15, 2010
(86) PCT No.: PCT/US10/52877

§ 371 Date: May 30, 2012

Related U.S. Application Data
(60) Provisional application No. 61/253,580, filed on Oct. 21, 2009.

(51) Int. Cl. B32B 5/26; B05D 3/02

(52) U.S. Cl. 442/372; 427/195

(57) ABSTRACT

Porous multilayer articles and methods of making are disclosed. Multicomponent polymeric fibers are introduced into a forming chamber and are deposited onto a first porous substrate. The multicomponent fibers are then bonded to each other to form a porous coherent web, and the porous coherent web is bonded to the first porous substrate, so as to form a porous multilayer article. The porous coherent web contains particles that are bonded to the multicomponent fibers of the web. The particles in the porous coherent web may be e.g. abrasive, absorbent, etc.

This application claims the benefit of U.S. Provisional Application No. 61/253,580, filed Oct. 21, 2009, which is incorporated by reference herein in it's entirety.

### BACKGROUND

The present invention relates to porous multilayer articles and methods of making. Such articles are often used for multifunctional scrubbing, e.g. of surfaces. For example, one porous layer may perform a scouring and/or abrading function while another porous layer may perform a wiping and/or absorbing function. Such porous multilayer articles are often produced by forming two porous layers and then bringing the preformed layers together and joining them to each other.

Often, one or both porous layers of such an article comprise a nonwoven web. Such nonwoven webs may range in structure and properties, e.g. from dense to open, from hard to soft, from rigid to flexible, and so on.

### SUMMARY

Porous multilayer articles and methods of making are disclosed. Multicomponent polymeric fibers are introduced into a forming chamber and are deposited onto a first porous substrate. The multicomponent fibers are then bonded to each other to form a porous coherent web, and the porous coherent web is bonded to the first porous substrate, so as to form a porous multilayer article. The porous coherent web contains particles that are bonded to the multicomponent fibers of the web. The particles in the porous coherent web may be e.g. abrasive, absorbent, etc.

Thus, in one aspect, disclosed herein is a method of making a porous multilayer web, comprising: introducing discontinuous multicomponent polymeric fibers into a forming chamber; introducing particles into the forming chamber; mixing the multicomponent fibers and particles within the forming chamber; depositing the multicomponent fibers and particles onto a first porous web to form a porous, particle-containing fibrous mat atop the first porous web; and, exposing the porous, particle-containing fibrous mat to an elevated temperature to melt-bond at least some of the multicomponent fibers to each other and to melt-bond at least some of the multicomponent fibers to at least some of the particles, so as to produce a particle-containing, coherent porous web, wherein the elevated temperature also causes the particle-containing coherent porous web and the first porous web to melt-bond together to form a porous, multilayer web.

In another aspect, herein is disclosed a porous multilayer article, comprising: a first porous nonwoven layer comprising polymeric fibers and abrasive particles bonded thereto; a second porous nonwoven layer comprising discontinuous multicomponent polymeric fibers at least some of which are melt-bonded to each other at least at some points of fiber contact, and comprising absorbent particles melt-bonded to at least some of the multicomponent fibers; wherein the first and second porous nonwoven layers are melt-bonded to each other.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a cross sectional view of an exemplary multilayer porous article as disclosed herein.

FIG. 2 is an exploded cross sectional view of a portion of one porous layer of the article of FIG. 1.

FIG. 3 is a side view in partial cutaway showing an exemplary process for making a multilayer porous article.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only unless otherwise noted.

### DETAILED DESCRIPTION

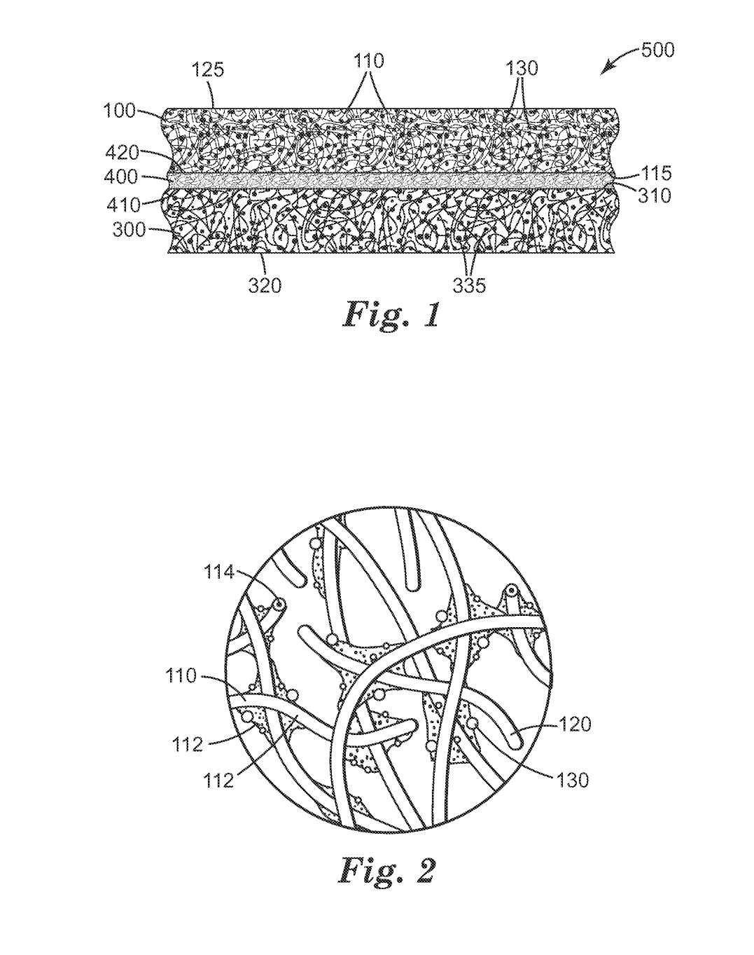

An exemplary porous multilayer article 500 is shown in FIG. 1. Article 500 is comprised at least of first porous layer 300, and second porous layer 100 that contains particles. Article 500 may optionally comprise a heat-activatable web 400 between first porous layer 300 and second porous layer 100 and that may be used to melt-bond porous layers 100 and 300 together. First porous layer 300 may comprise any porous substrate (e.g., web) upon which it is desired to form particle-containing second porous layer 100 by methods described herein. In some embodiments, porous layer 300 may comprise particles 335, which may be chosen from any of the particles described in detail herein. In particular embodiments, porous layer 300 may comprise abrasive particles as described in detail herein. Porous layer 300 may comprise first major surface 310, which may be bonded, either directly or indirectly, to a major surface of second porous layer 100 in the formation of porous article 500, and may comprise second major surface 320, which may become a major outer surface of porous multilayer article 500.

Porous layer 300 may range in properties from rigid to flexible, hard to soft, thick to thin, and so on. In some embodiments, porous layer 300 may comprise a cloth material (such as a knitted or woven cloth or a microfibrillated cloth), a plastic netting or mesh material, a metal mesh or screen material, and the like.

In some embodiments, porous layer 300 may comprise a nonwoven web. In particular embodiments, porous layer 300 may comprise a coherent nonwoven web (i.e. a web possessing sufficient mechanical integrity that it can be handled in roll or sheet form so as to be introduced into the process described later herein in which second porous layer 100 is formed upon first porous layer 300). In further embodiments, porous layer 300 may comprise a coherent nonwoven web that is a bonded-fiber web (i.e., a web in which at least some of the fibers are bonded to each other at points of contact between the fibers, either by adhesive (binder), by melt-bonding, or the like).

In some embodiments, porous layer 300 may comprise a coherent bonded-fiber nonwoven web made of interlaced randomly disposed flexible organic thermoplastic fibers at least some of which are adhesively bonded together by binder at points where the fibers intersect and contact each other, to form a web having three-dimensionally integrated structure. Abrasive particles may be distributed throughout the web and bonded to the web by binder. The interstices between the fibers of the web are substantially unfilled with binder or abrasive. In one embodiment, the web includes a three-dimensionally extending network of intercommunicated voids such that the web includes, on average, at least about 75% by volume voids, at least about 85% by volume voids, at least about 90% by volume voids or even at least about 95% by volume voids. The web is flexible and readily compressible and, upon release of pressure, is capable of recovering substantially completely to its initial uncompressed form. Examples of webs of this type are disclosed in U.S. Pat. No. 2,958,593, which is incorporated herein by reference. Webs of this type are available from 3M Company, St. Paul, Minn. under the trade designation SCOTCH-BRITE.

In some embodiments, porous layer 300 may comprise a coherent bonded-fiber nonwoven web made of first and second crimped, staple, organic bicomponent thermoplastic fibers, in which at least some of the first and second fibers of the web are melt-bonded together at least at a portion of the points where they contact each other. At least a portion of the first and second fibers of one major surface of the nonwoven web may have an abrasive coating (e.g., abrasive particles) bonded thereto, and at least a portion of the first and second fibers of the interior region may have no abrasive coating bonded thereto. Examples of webs of this type are disclosed in U.S. Pat. No. 5,685,935, which is incorporated herein by reference. Webs of this type are available from 3M Company, St. Paul, Minn. under the trade designation SCOTCH-BRITE.

In some embodiments, porous layer 300 may comprise a coherent bonded-fiber nonwoven web made of inter-engaged continuous coiled or three-dimensionally undulated filaments of resilient thermoplastic polymer. At least some of the filaments are autogeneously bonded together or removably welded together at points of mutual contact to form a handleably integrated structure. The web may comprise abrasive granules dispersed throughout the web and bonded to the filaments by binder. Examples of webs of this type are disclosed in U.S. Pat. Nos. 3,837,988 and 4,227,350, which are incorporated herein by reference. Webs of this type are available from 3M Company, St. Paul, Minn. under the trade designation NOMAD.

In some embodiments, porous layer 300 may comprise a coherent bonded-fiber nonwoven web that is a sponge-like, compressible, web made of randomly intermingled and randomly bonded hydrophobic fibers. The randomly intermingled fibers are bonded together either through fusion or with a binder at randomly spaced points where the fibers cross. The fibers of the web define, in effect, walls of a large multiplicity of open cells, which impart a high void volume to the web. Examples of webs of this type are disclosed in U.S. Pat. No. 3,537,121 and U.S. Pat. No. 3,910,284, both of which are incorporated herein by reference. Webs of this type are available from 3M Company, St. Paul, Minn. under the trade designation BUF-PUF.

In some embodiments, porous layer 300 may comprise a coherent bonded-fiber web comprising irregularly looped and intermingled filaments in a highly porous, open, three-dimensional sheet structure. The filaments may be self-bonded (e.g., melt-bonded) to each other at points of fiber contact, and/or may form a peak-and-valley three-dimensional structure. Examples of webs of this type are disclosed in U.S. Pat. No. 4,212,692, U.S. Pat. No. 4,252,590, and U.S. Pat. No. 6,272,707, all of which are incorporated by reference herein. Webs of this type are available from Colbond Company of St. Denis La Plaine, France, under the trade designation ENKAMAT.

Porous layer 300 may comprise any suitable thickness, basis weight, and the like. In various embodiments, porous layer 300 is at least about 1 mm, at least about 2 mm, or at least about 4 mm, in thickness. In further embodiments, porous layer 300 is at most 30 mm, at most about 20 mm, or at most about 15 mm, in thickness. In various embodiments, porous layer 300 may comprise a basis weight of at least 50 gsm (grams per square meter), at least 100 gsm, or at least 200 gsm. In further embodiments, porous layer 300 may comprise a basis weight of at most 4000 gsm, 3000 gsm, or 2000 gsm.

To enhance the ability to deposit multicomponent fibers 110 and particles 130 atop a major surface of porous layer 300, porous layer 300 may comprise voids with, on average, a maximum size (e.g., diameter, or equivalent diameter since most such voids may be irregular in shape) of less than about 4 mm, less than about 2 mm, or less than about 1 mm.

Porous layer 300 may comprise particles, e.g. abrasive particles, as desired, including any of the abrasive particles disclosed herein. In such case, porous layer 300 may be particularly suited to serve as a scouring, abrading, or polishing layer of porous multilayer article 500, as discussed later herein.

If desired, porous layer 300 may comprise a binder. Such a binder may be present e.g. throughout the thickness of layer 300; or it may comprise a binder coating at least at or on major surface 310 of layer 300, e.g. to enhance the bonding of porous layer 100 to porous layer 300. The binder may be a resin (e.g. phenolic resins, polyurethane resins, polyureas, styrene-butadiene rubbers, nitrile rubbers, epoxies, acrylics, and polyisoprene). The binder may be water soluble, as is well known in the art.

Shown in FIG. 1, and in exploded cross sectional view in FIG. 2, is particle-containing second porous layer 100, which may be formed by methods described herein. Porous layer 100 may comprise first major surface 115, which may be bonded, either directly or indirectly, to major surface 310 of first porous layer 300 in the formation of porous multilayer article 500, and may comprise second major surface 125, which may become a major outer surface of porous multilayer article 500. Layer 100 comprises at least multicomponent fibers 110 and particles 130. Multicomponent fibers 110 are defined as fibers having at least a first major polymeric portion (component) 112 with a first melting point and a second major polymeric portion (component) 114 with a higher melting point than that of portion 112. Such multicomponent fibers may be bicomponent fibers, or may have additional components as well. Upon exposure to an appropriate elevated temperature, first portion 112 may at least partially melt, while second portion 114 with a higher melting point may remain generally intact. During melting, the first portion 112 may tend to collect at junction points where fibers contact each other, e.g. as shown in FIG. 2. Then, upon cooling, the material of the first portion 112 may resolidify and in so doing bond at least some of the fibers 110 to each other (such a process is commonly defined as melt-bonding). Also, at least some of the at least partially melted portions 112 may come into contact with particles 130 and may, upon solidification, act to hold at least some of the particles in contact with at least some of the fibers 110 (i.e., to melt-bond the particles to fibers 110). Thus, the use of multicomponent fibers 110 provides for melt-bonding at least some of fibers 110 to each other such that porous layer 100 comprises a bonded-fiber, coherent web (i.e., a web in which a sufficient number of the fibers are melt-bonded to each other that the web has sufficient mechanical integrity to be handled and used without unacceptably coming apart), and for melt-bonding at least some of particles 130 to fibers 110. These may all be accomplished without the need of an additional resin coating, binder, or adhesive, to be present in porous layer 100.

Multicomponent fibers 110 may be discontinuous (defined for purposes of this disclosure as meaning less than eight cm long). In various embodiments, fibers 110 may be less than about four cm, less than about two cm, or less than about one cm long. In further embodiments, multicomponent fibers 110 may be at least about 2 mm, at least about 4 mm, or at least about 6 mm long. In some embodiments, multicomponent fibers 110 may comprise a mixture of longer fibers and shorter fibers. In some embodiments, discontinuous fibers 110 may be cut fibers (e.g., chopped, from longer length and/or continuous fibers).

In various embodiments, fibers 110 may comprise a Denier of at least one, or at least two, or at least three. In further embodiments, fibers 110 may comprise a Denier of less than about 80, less than about 60, or less than about 40. In some embodiments, multicomponent fibers 110 may comprise a mixture of higher Denier (larger diameter) fibers and lower Denier (smaller diameter) fibers. In some embodiments, multicomponent fibers 110 may comprise a mixture of fibers of Denier between one and five, with fibers of Denier between ten and twenty.

Multicomponent fibers 110 may be synthetic polymeric fibers, for example bicomponent fibers, with at least a first major polymeric portion with a first melting point and a second major polymeric portion with a second melting point that is higher (e.g., 20, 40, or 60 degrees C. higher or more) than the first melting point. Often, polyolefins (e.g., polyethylene or copolymers thereof) may be used for the first, lower melting point component, and polyesters (e.g., PET and the like) may be used for the second, higher melting point component. Or, certain polyolefins (e.g. polyethylene) may be used for the first component and other, higher melting point polyolefins (e.g., polypropylene) may be used for the second component. Or, certain polyesters (e.g. polybutylene succinate) may be used for the first component and other polyesters (e.g., polyethylene terephthalate succinate) may be used for the second component. One or both of the components may be biodegradable, if desired.

Multicomponent fibers, e.g. bicomponent fibers, may be used that have e.g. a coextensive side-by-side configuration, a coextensive concentric sheath-core configuration (e.g., as in the exemplary embodiment of FIG. 2), or a coextensive elliptical sheath-core configuration. Other arrangements (e.g.., layered structures, lobed structures, segmented structures, islands-in-the-sea structures, matrix-fibril, and so on) are also possible.

In addition to first major polymeric portion 112 and second major polymeric portion 114, multicomponent fibers 110 may comprise any of the additives known to those of skill in the art. Such additives may include plasticizers, processing aids, pigments, antioxidants, stabilizers, compatibilizing agents, impact-resistance modifiers, pigments, mineral fillers, dyes, surfactants, lubricants, and so on.

Exemplary materials that may be used as multicomponent fibers 110 may include materials available from Minifibers, Inc. of Johnson City, Tenn., under the trade designation Bicomponent Fibers, material available from KoSa Co. of Wichita, Kans., the under the trade designation CELBOND 254, materials available from Trevira GMBH of Bobingen, Germany, under the trade designation Bicomponent Fibres, materials available from available from Unitika Co. of Osaka, Japan, under the trade designation MELTY, materials available from Huvis Corporation of Seoul, Korea under the trade designation LMF, materials available from Invista Corp of Wichita, Kans. under the trade designations T 254 and T 256, materials available from Chisso Inc. of Osaka, Japan, under the trade designations Chisso ES, ESC, EAC, EKC, EPC and ETC, and material available from Nan Ya Plastics Corporation of Taipei, Taiwan, under the trade designation Type LMF.

In general, the greater the percentage of the total fibers of layer 100 that is provided by multicomponent fibers 110, the higher the possible loading of particles 130 within layer 100. In various embodiments, at least 10 wt. %, at least 20 wt. %, or at least 40 wt. %, of the total fiber content of porous layer 100 is supplied by multicomponent fibers 110. In particular embodiments, all of the total fiber content of layer 100 is supplied by multicomponent fibers 110. In alternative embodiments, optional filling fibers 120 are blended with the multicomponent fibers 110. Filling fibers 120 are any kind of fiber other than a multicomponent fiber. Examples of filling fibers 120 include single component synthetic fibers, semi-synthetic fibers, metal fibers, natural fibers, mineral fibers, and so on.

The properties of multicomponent fibers 110 and of optional filling fibers 120 may be chosen to provide porous layer 100 with the desired characteristics. Generally, a larger fiber diameter, a longer fiber length, and the presence of a crimp in the fibers, may provide a more open and lofty nonwoven layer. Generally, smaller diameter, shorter, and/or uncrimped fibers may result in a more compact nonwoven article. Generally, higher amounts of multicomponent fiber may result in a stiffer nonwoven layer. Further, polymer type (e.g.,. composition) may also affect the stiffness of the nonwoven article. Given these factors, the various parameters of multicomponent fibers 110, and of optional filling fibers 120, can be chosen as desired (e.g., in combination with the type of particle 130 included in layer 100) so that porous layer 100 can function in any capacity chosen e.g. from those presented herein. That is, porous layer 100 may serve e.g. as a relatively rigid, open, abrasive-containing layer e.g. for scouring; as a relatively flexible absorbent-containing layer e.g. for sponging; as a compact, drapeable wipe e.g. for dusting; and so on (all of these exemplary uses may fall under the general category of scrubbing). These examples are not meant to be limiting and those of skill in the art will readily appreciate that many variations and combinations are possible.

Porous layer 100 may comprise any suitable thickness, basis weight, and the like. In various embodiments, porous layer 100 is at least about 2 mm, at least about 5 mm, or at least about 10 mm, in thickness. In further embodiments, porous layer 100 is at most 40 mm, at most about 30 mm, or at most about 20 mm, in thickness. In various embodiments, porous layer 100 may comprise a basis weight of at least about 100 gsm (grams per square meter), at least about 200 gsm, or at least about 400 gsm. In further embodiments, porous layer 100 may comprise a basis weight of at most about 4000 gsm, at most about 2000 gsm, or at most about 1500 gsm.

If desired, porous layer 100 may comprise an optional binder. Such a binder may be present e.g. throughout the thickness of layer 100; or it may be present primarily at or near major surface 115 of layer 100 (e.g., as obtained by methods disclosed herein), e.g. to enhance the bonding of porous layer 100 to porous layer 300. Or, such a binder may be present primarily at or near major surface 125, e.g. to enhance the bonding of any optionally attached layer to this surface of porous layer 100. The binder may be a resin (e.g. phenolic resins, polyurethane resins, polyureas, styrene-butadiene rubbers, nitrile rubbers, epoxies, acrylics, and polyisoprene). The binder may be water soluble, as is well known in the art.

Layer 100 will comprise particles 130, and layer 300 may optionally contain particles 335. While such particles are discussed herein primarily in the context of particles 130 of layer 100, it is understood that any of the herein-described particles may be present as particles 335 in layer 300. Such particles can be any discrete particle, which is a solid at room temperature, that is added e.g. to provide a cleaning, scouring, polishing, wiping, absorbing, adsorbing, or sensory benefit. In various embodiments, such particles may comprise an average diameter of less than about 1 cm, less than about 5 mm, less than about 2 mm, or less than about 1 mm. In further embodiments, such particles may comprise an average diameter of at least about 50 microns, at least about 100 microns, or at least about 250 microns.

In some embodiments, particles 130 and/or optional particles 335 are abrasive particles. Abrasive particles may be used to provide an abrasive porous layer that can scour and abrade difficult to remove material. Abrasive particles may be mineral particles, synthetic particles, natural abrasive particles or a combination thereof. Examples of mineral particles include aluminum oxide such as ceramic aluminum oxide, heat-treated aluminum oxide and white-fused aluminum oxide; as well as silicon carbide, alumina zirconia, diamond, ceria, cubic boron nitride, garnet, flint, silica, pumice, and calcium carbonate. Synthetic particles include polymeric materials such as polyester, polyvinylchloride, methacrylate, methylmethacrylate, polycarbonate, melamine, and polystyrene. Natural abrasive particles include nutshells such as walnut shell, or fruit seeds such as apricot, peach, and avocado seeds.

Various sizes, hardness, and amounts of abrasive particles may be used to create an abrasive porous layer ranging from very strongly abrasive to very lightly abrasive. In some embodiments, the abrasive particles have a size greater than 1 mm in diameter. In other embodiments, the abrasive particles have a size less than 1 cm in diameter. In some embodiments, a combination of particles sizes and hardness can be used to give a combination of abrasiveness that is strong without scratching. In certain embodiments, the abrasive particles include a mixture of soft particles and hard particles.

In some embodiments particles 130 and/or optional particles 335 are metal, and e.g. may be used to provide a polishing layer. The metal particles may be in the form of short fiber or ribbon-like sections or may be in the form of grain-like particles. The metal particles can include any type of metal such as but not limited to steel, stainless steel, copper, brass, gold, silver (which has antibacterial/antimicrobial properties), platinum, bronze or blends of one or more of various metals.

In some embodiments, particles 130 and/or optional particles 335 are solid materials typically found in detergent compositions, such as surfactants and bleaching agents. Examples of solid surfactants include sodium lauryl sulfate and dodecyl benzene sulfonate. Other examples of solid surfactants can be found in “2008 McCutcheon's Volume I: Emulsifiers and Detergents (North American Edition)” published by McCuthcheon's Division. Examples of solid bleaching agents include inorganic perhydrate salts such as sodium perborate mono- and tetrahydrates and sodium percarbonate, organic peroxyacids derivatives and calcium hypochlorite.

In some embodiments, particles 130 and/or optional particles 335 are solid biocides or antimicrobial agents. Examples of solid biocide and antimicrobial agents include halogen containing compounds such as sodium dichloroisocyanurate dihydrate, benzylkoniumchloride, halogenated dialkylhydantoins, and triclosan.

In some embodiments, particles 130 and/or optional particles 335 are microcapsules. Microcapsules are described in U.S. Pat. No. 3,516,941 to Matson and include examples of the microcapsules that can be used as particles 130 or 335. The microcapsules may be loaded with solid or liquid fragrance, perfume, oil, surfactant, detergent, biocide, or antimicrobial agents. One of the main qualities of a microcapsule is that by means of mechanical stress the particles can be broken in order to release the material contained within them. Therefore, during use of article 500, the microcapsules may be broken due to the pressure exerted on layer 100 and/or 300, which may release the material contained within the microcapsule.

In some embodiments, particles 130 and/or optional particles 335 are adsorbent or absorbent particles. For example, adsorbent particles could include activated carbon, charcoal, sodium bicarbonate, and the like. In certain embodiments, particles 130 and/or optional particles 335 are absorbent (i.e., able to absorb significant quantities of liquid water and/or aqueous compositions, solutions, and mixtures). For example, absorbent particles could include porous material, natural or synthetic foams such as melamine, rubber, urethane, polyester, polyethylene, silicones, and cellulose. The absorbent particles could also include superabsorbent particles such as sodium polyacrylates, carboxymethyl cellulose, or granular polyvinyl alcohol.

In various embodiments, the absorbent particles may have a diameter (or equivalent diameter, if nonspheroidal or irregular in shape), on average, of less than about 1 cm, less than about 5 mm, less than about 2 mm, or less than about 1 mm. In further embodiments, the particles may have a diameter or equivalent diameter, on average, of greater than about 20 microns, greater than about 50 microns, greater than about 100 microns, or greater than about 200 microns.

In particular embodiments with respect to porous layer 100, particles 130 may comprise chopped cellulosic sponge particles or chopped urethane sponge particles or mixtures thereof. Such particles may be advantageously provided by e.g. chopping of waste sponge material left over from the production of conventional monolithic cellulosic or urethane sponges. It has been found that porous layer 100 with e.g. cellulosic sponge particles 130 bonded therein can be highly hydrophilic and water-absorbent. In addition, layer 100 with e.g. cellulosic sponge particles 130 bonded therein may remain flexible and drapeable even following drying (typically, monolithic cellulose sponges become rigid and less flexible upon drying). And, even though such sponge particles are typically composed of very different (e.g., hydrophilic) materials than the materials that comprise portions 112 of multicomponent fibers 110 (which are often quite hydrophobic materials such as polyolefins), it has been found that such sponge particles may bond well to multicomponent fibers 110 of layer 100 and may remain bonded even after absorbing significant amounts of water.

Those of ordinary skill in the art will appreciate that any combination of one or more of the above described particles 130 may be used within porous layer 100 and/or within porous layer 300. For example, porous layer 100 and/or porous layer 300 may contain water-absorbent particles and/or detergent particles and/or abrasive particles and/or biocide particles and/or microcapsules, in any or all conceivable combinations.

With specific regard to particles 130, depending on the desired attributes of porous layer 100, a variety of loadings of particles 130 relative to multicomponent fibers 110 (and filling fibers 120 if included) may be used. In various embodiments, particles 130 may comprise less than about 90, less than about 80, or less than about 70, % by weight of the total weight of porous layer 100. In further embodiments, particles 130 comprise at least 10, at least 20, or at least 30, % by weight of the total weight of porous layer 100.

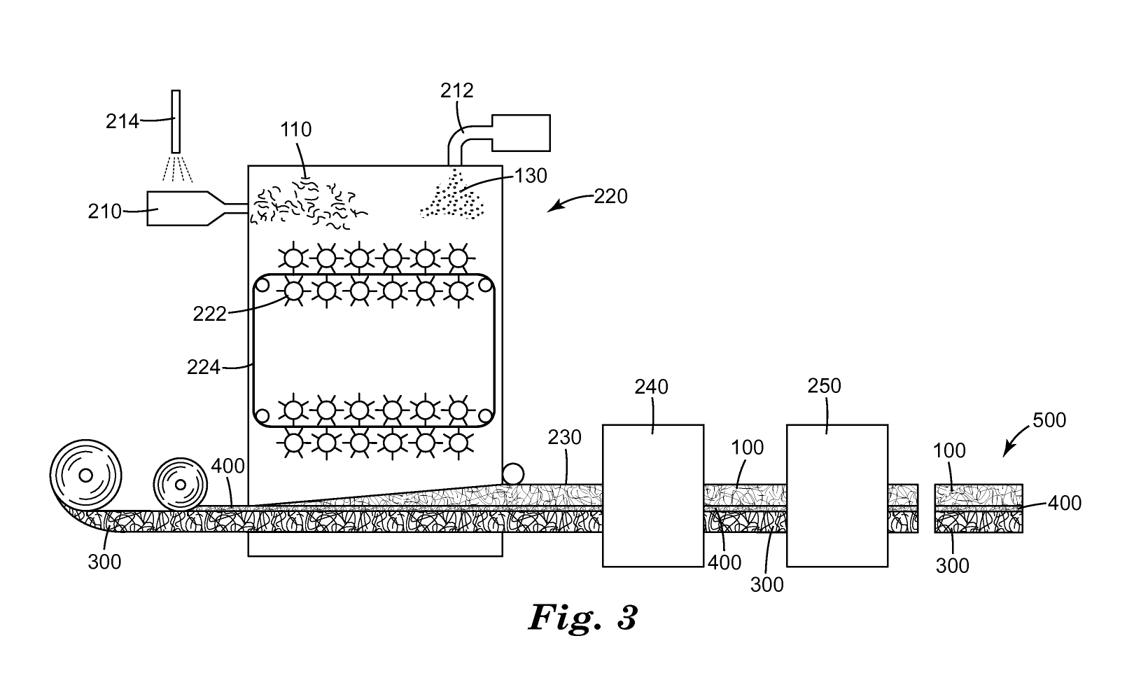

FIG. 3 is a side view (with chamber 220 in cutaway) showing an exemplary process of making porous multilayer article 500. A fiber input stream 210 introduces fibers (i.e., including multicomponent fibers 110) into forming chamber 220 where the fibers are mixed, blended, and ultimately deposited onto first porous substrate (e.g., web) 300 (which ultimately becomes first porous layer 300 of finished porous multilayer article 500). Prior to entering forming chamber 220, an opener (not shown) may be included to open, comb, and/or blend the input fibers, particularly if a blend of multicomponent fibers 110 and filling fibers 120 are included. Particles 130 are also introduced into forming chamber 220, e.g. by way of particle input stream 212. While fiber input stream 210 and/or particle input stream 212 may be advantageously positioned generally toward the upper portion of forming chamber 220, it is understood that either or both of these may be positioned at other portions of forming chamber 220. For example the particle input stream 212 can be introduced in the middle or at the bottom of the forming chamber 220.

Forming chamber 220 is a type of dry-laying fiber processing equipment, such as shown and described in U.S. Patent Application Publication 2005/0098910 titled “Fiber distribution device for dry forming a fibrous product and method,” the disclosure of which is herein incorporated by reference. Instead of using strong air flow to mix and interengage the fibers to form a mat (such as with a “RandoWebber” web forming machine, available from Rando Machine Corporation, Macedon, N.Y.), forming chamber 220 has spike rollers 222 to mechanically blend and mix the fibers while gravity allows the fibers to fall down through moving endless belt screen 224 and to ultimately be deposited onto porous substrate 300 to form fibrous mat 230 comprised of e.g. unbonded fibers. In this design, the mixed fibers and particles 130 both fall together (are gravity-dropped) toward the bottom of the forming chamber 220 to form mat 230 atop porous substrate 300. In general, multicomponent fibers 110 and particles 130 are processed in chamber 220 at temperatures significantly lower (e.g., at least 30 degrees C. lower) than the melting temperatures of any portion (e.g., first portion 112) of multicomponent fibers 110.

Various fibers and particles can be added in this manner, as explained herein and as further discussed in U.S. patent application Ser. No. 12/251,048, filed Oct. 14, 2008, entitled Nonwoven Material Containing Benefiting Particles and Method of Making; which is herein incorporated by reference.

Porous substrate 300 may either be passed into and through a lower portion of forming chamber 220, or may be passed underneath an opening in the bottom of forming chamber 220, so that the fibers and particles can be deposited thereon. Porous substrate 300 may be so passed as a free-standing, self-supporting layer; or it may be residing upon, or carried by, a portion of an endless fiber-collection belt of the type often used in airlaying equipment.

An at least partial vacuum may be applied to the bottom surface (e.g., major surface 320) of porous substrate 300, by way of which a pressure differential can be applied through the thickness of porous substrate 300 to assist in the deposition of fibers and particles onto porous substrate 300. If a supporting belt or screen is used (e.g., below porous substrate 300 and at least partially supporting it from beneath), such a belt or screen may be porous so that the vacuum can be applied through it.

Porous substrate 300 with fibrous mat 230 thereupon then proceeds to heating unit 240, such as an oven, in which an elevated temperature exposure is performed. This elevated temperature serves a first purpose of exposing fibrous mat 230 to a temperature at which first portions 112 of multicomponent fibers 110 of fibrous mat 230 may at least partially melt to bond at least some of fibers 110 to each other and to bond at least some of particles 130 to fibers 110, to transform fibrous mat 230 into coherent web 100 as described herein (these melt-bonding processes may not be fully completed until the materials are cooled subsequent to the elevated temperature exposure such that first portions 112 of fibers 110 resolidify, of course). The elevated temperature exposure may also serve a second purpose of melt-bonding mat 230/coherent web 100 to porous substrate 300, such that porous layer 100 is sufficiently well attached to porous layer 300 that the thus-formed porous multilayer web can be separated (e.g., cut) through its thickness to form porous multilayer articles 500 as shown in FIG. 3. This formation of coherent web 100 atop porous substrate 300 and particularly the bonding of porous layer (coherent web) 100 to porous substrate 300 to form a porous, multilayer structure, is to be contrasted with the conventional temporary deposition of a fibrous mat onto an endless fiber-collection belt and the subsequent removal of the thus-formed web from the endless belt.

The melt-bonding of mat 230/coherent web 100 to porous substrate 300 may be performed in a variety of ways. In some embodiments, if the compositions of multicomponent fibers 110 of porous layer 100 and of the material (e.g., nonwoven fibers) of porous layer 300 are appropriately chosen, fibers 110 may be deposited directly onto surface 310 of porous substrate 300, and it may be possible to then directly melt-bond at least some of fibers 110 to the fibers of porous substrate 300, such that porous layer 100 and porous layer 300 are directly melt-bonded together. Those of ordinary skill in the art will appreciate that in the deposition of fibers 110 (as well as optional fibers 120, if present) onto a surface of porous substrate 300, some number of such fibers may penetrate partially into the interior of porous substrate 300. This may depend on the porosity and openness of the structure of porous substrate 300, the diameter and length of the fibers, and so on. However, in general such penetration may be only slight (e.g. with fibers 110 penetrating into porous substrate 300 to a depth of no more than about 10% of the thickness of porous substrate 300). Methods and apparatus which may be used to significantly and/or substantially fill the interior of a porous substrate with multicomponent fibers so as to form a web embedded therein, are disclosed in detail in copending and commonly assigned U.S. patent application Ser. No. ______, entitled “Porous Supported Articles and Methods of Making”, 3M docket number 65832US002, filed on evendate herewith and incorporated by reference herein.

In other embodiments, a separate, heat-activatable web 400 may be used (e.g. as shown in FIG. 3), that is placed near or upon porous substrate 300 (e.g., with major surface 410 of web 400 adjacent to, and in overlapping relation with, major surface 310 of porous substrate 300). As porous substrate 300 and heat-activatable web 400 adjacent thereto are passed through or beneath forming chamber 220, fibers and particles within chamber 220 may be deposited onto major surface 420 of heat-activatable web 400. (Those of ordinary skill in the art will appreciate that in such embodiments, the above-described depositing of fibers and particles onto porous substrate 300 specifically encompasses the deposition of such fibers and particles onto web 400 that is adjacent to or in contact with porous substrate 300). When vacuum is used to assist the deposition, web 400 should be sufficiently porous to allow vacuum applied to major surface 320 of porous substrate 300 to cause sufficient pressure differential through the thickness of porous substrate 300 and porous web 400 to provide adequate assistance to the deposition process.

In such embodiments, porous substrate 300, with web 400 thereupon, and fibrous mat 230 thereupon, are exposed to elevated temperature sufficient to perform the above-mentioned bonding together of a sufficient number of fibers 110 of mat 230 to transform mat 230 into coherent web 100, and also sufficient to cause at least some fibers of heat-activatable web 400 to be sufficiently melted to enable web 400 to melt-bond fibrous mat 230 (coherent web 100) to porous substrate 300. That is, with reference particularly to FIG. 1, major surface 420 of web 400 may be bonded to major surface 115 of porous layer 100, and major surface 410 of web 400 may be bonded to major surface 320 of porous layer 300, such that layers 100, 300 and 400 are bonded together into a multilayer structure that can be cut completely through its thickness to provide individual porous multilayer articles 500.

Heat-activatable web 400 may comprise any suitable material that can be activated by exposure to appropriately elevated temperature. Particularly in embodiments in which a vacuum is used to assist in the deposition of fibers and/or particles, it may advantageous that web 400 be porous, as mentioned. Web 400 may comprise monocomponent fibers, multicomponent fibers, etc., as desired. It may be particularly advantageous to choose the composition of at least some of the fibers of web 400 to comprise a melting point similar to (e.g., within about 25 degrees above or below) the melting point of portions 112 of fibers 110. This may provide that the same elevated temperature exposure can serve to melt-bond fibers 110 together as described previously herein, to melt-bond particles 130 to fibers 110 as described previously herein, and also to allow heat-activatable web 400 to melt-bond fibrous mat 230 (coherent web 100) to porous substrate 300. In various embodiments, such heat-activatable webs may have a basis weight of at least 5, at least 10, or at least 20 gsm. In further embodiments, such heat-activatable webs may have a basis weight of at most 100, at most 70, or at most 50 gsm.

Heat activatable porous webs that may be suitable include e.g. those products available from ProTechnics (Cernay, France) under the trade designation Texiron.

In other embodiments, it may be advantageous to use a separately added binder (which may be added in the form of particles within forming chamber 220, or in the form of a binder present upon (e.g., previously coated upon) surface 310 of porous substrate 300 and/or within some or all of the thickness of porous substrate 300), to assist the bonding of fibrous mat 230 (coherent web 100) to porous substrate 300. Such binders present upon or within porous substrate 300 may include those types of binders listed previously herein. If particulate binders are to be added within forming chamber 220, the properties of porous substrate 300 may need to be chosen appropriately (e.g., such that the binder particles preferentially collect at or near surface 310 of porous substrate 300 rather than penetrating unacceptably therethrough).

In some embodiments, the process described herein may be operated such that particles 130 are incorporated into mat 230 (and ultimately reside within porous layer 100 formed therefrom) throughout the thickness of mat 230 (e.g., generally uniformly through out the thickness of mat 230). In some cases this may be enhanced by optionally introducing liquid solution 214, such as an aqueous solution, into chamber 220. The liquid solution 214 may wet at least some of the fibers so that particles 130 cling to the surface of the fibers, which may enhance the dispersing of particles 130 generally throughout the thickness of mat 230. (When mat 230 proceeds to heating unit 240, the liquid solution 214 may evaporate and play no further role in the processing). In other embodiments, particles 130 may reside e.g. preferentially on or near major surface 125 of web 100. This may be provided e.g. when the mat 230 is a relatively dense web with small openings, such that particles 130 remain preferentially on or near the uppermost surface of mat 230.

Elevated temperature exposure may be achieved e.g. by use of any suitable heating unit or units 240, e.g. one or more ovens. In particular embodiments, heating unit 240 may comprise a so-called through-air bonder, in which heated air under positive pressure is forced through the thickness of mat 230 and porous substrate 300 (and porous web 400 if present) so as to enhance the uniformity of the temperature exposure and to promote uniform bonding. In other embodiments, either in place of, or in addition to, such an oven exposure and/or through-air bonding, the elevated temperature exposure may occur with the application of pressure, e.g. by passing mat 230 and porous substrate 300 (and web 400 if present) through one or more heating units 240 comprising sets of heated calendering rolls. In some embodiments, however (even if such a calendering step is performed), mat 230 is not significantly densified in the process of bonding (e.g., in such embodiments the thickness of porous layer 100 may be at least 80%, at least 90%, or at least about 95% of the thickness of mat 230 from which it is formed).

Various steps, e.g. post-processing steps, as performed e.g. by post-processing unit 250 of FIG. 3, may be performed e.g. to add strength or texture to finished article 500. For example, either or both of porous layer 100 and porous layer 300 (and web 400 if present) may be needle-punched, calendered, hydroentangled, etc., e.g., so as to enhance the integrity of the layer or to enhance bonding together of the layers. One or more of porous layers 100 or 300 may be embossed, may be laminated to an additional layer, may have a binder coating deposited thereon, and the like, as desired.

Typically, the above-described multilayer web comprising porous layer 300 and particle-containing, porous layer 100 bonded thereto (and web 400 if present) may be separated (e.g., cut) through the thickness of all of the webs, to form individual porous multilayer articles 500, as shown in FIG. 3. Those of skill in the art will appreciate the advantages of producing articles 500 by way of forming porous layer 100 atop porous layer 300 in the herein-described deposition/bonding process, as opposed to the conventional procedure of forming the two layers separately and them laminating them together subsequently.

It will be understood that a variety of products can be made from the above-described porous layers 100 and 300, involving any suitable combination of the components and properties listed thereof. Thus in various embodiments, particle-containing porous layer 100 may comprise an absorbent layer (which may contain absorbent particles and which may serve at least partially to absorb water or aqueous mixtures), or a wipe layer (which may serve at least partially to receive loose small particulates, dust and the like), or a scouring layer (which may contain abrasive particles and may serve to dislodge materials from surfaces), and so on. Likewise, porous layer 300 may comprise an absorbent layer, or a wipe layer, or a scouring layer, and so on. Any combination of the above-listed types of porous layer 100 and types of porous layer 300 is within the scope of this disclosure, noting that these include combinations in which layer 100 and layer 300 comprise different types of functionality, and combinations in which layer 100 and layer 300 comprise the same type of functionality (e.g., in which layer 100 and layer 300 are both scouring layers, but contain abrasive particles that are different in size and/or hardness). If desired, a another porous layer 100 may be provided on an opposite side of porous layer 300 from the aforementioned porous layer 100 (such an additional porous layer 100 may be of the same, or different, thickness and/or composition as the aforementioned porous layer 100). All of the above-described embodiments may generally fall into the category of scrubbing (e.g. of surfaces), e.g. for home, residential, commercial use and the like.

In certain embodiments, particle-containing porous layer 100 may serve at least as an absorbent layer that contains absorbent particles 130 (e.g., chopped urethane or cellulosic sponge particles), and porous layer 300 may serve at least as a scouring layer that comprises abrasive particles. In specific embodiments of this type, porous layer 300 comprises a coherent bonded-fiber nonwoven web comprising abrasive particles, with the web being of a type generally corresponding to those abrasive-containing, nonwoven scouring products described herein and commercially available from 3M Company under the trade designation SCOTCH-BRITE.

Those of skill in the art will appreciate that a variety of articles 500 can be made based on the disclosures herein, involving any suitable combination of the structures, components and properties listed herein. Many such articles may be useful in scrubbing applications (e.g. for scrubbing of surfaces), whether such scrubbing is performed by hand or by the operation of machinery (e.g., floor scrubbers and the like). Those of skill in the art will appreciate that article 500 as described herein may be used in situations where article 500 is moved relative to the surface to be scrubbed (e.g., as a floor scrubbing pad, surface finishing pad, scouring pad, or a component thereof), as well as scrubbing applications in which article 500 is held stationary and the surface to be scrubbed is moved relative to article 500. Uses other than scrubbing may also be envisioned.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention. Thus, the scope of the present invention should not be limited to the specific illustrative structures described herein, but rather by the structures described by the language of the claims, and the equivalents of those structures. To the extent that there is a conflict or discrepancy between this specification and the disclosure in any document incorporated by reference herein, this specification will control.

### EXAMPLES

Porous multilayer articles were produced via the use of an apparatus and process generally similar to that shown in FIG. 3. Sheath-core bicomponent fibers (sheath composed of polybutylene succinate, core composed of polyethylene terephthalate succinate), 3 Denier, and average length approximately 10 mm were obtained from Minifibers, Inc (Johnson City, Tenn.). Additional sheath-core bicomponent fibers (sheath composed of co-polyester (Co-PET), core composed of polyester (PET)), 15.5 Denier, and average length approximately 20 mm, were obtained from Huvis Corporation (Seoul, Korea). Chopped cellulosic sponge particles were obtained from 3M Company, of average size estimated at less than 2 mm (the particles were somewhat irregular in shape and appeared to comprise a fairly wide particle size distribution). The fibers and the particles were introduced into a forming chamber at feed rates that provided a nominal ratio of 3 De fibers:15.5 De fibers:sponge particles of 20:20:60 by weight.

A porous, abrasive nonwoven web (labeled a scouring pad by the supplier) was obtained from 3M Company under the trade designation SCOTCH-BRITE. The web was red in color and was approximately 7 mm in thickness. A porous, heat-activatable web was obtained from ProTechnics (Cernay, France) under the trade designation Texiron D38 −30 (30 gsm). This heat-activatable web comprised at least some fibers containing polyethylene and was listed by the manufacturer as having a dry heat activation temperature of 140-160° C.

The forming chamber was brought to appropriate steady-state operating conditions, in which the fibers and particles were processed by the spike rollers and the endless belt screen and then were gravity-dropped toward the bottom of the forming chamber onto an endless fiber-collection belt (a porous, mesh screen) that ran horizontally underneath the bottom of the forming chamber. A length of the above-described SCOTCH-BRITE web was placed onto the endless fiber-collection belt. A matching length of Texiron D38 web was stacked atop the length of SCOTCH-BRITE. The SCOTCH-BRITE/Texiron D38 stack was passed underneath the forming chamber at a speed of approximately 1 meter per minute. This speed was calculated in combination with the feed rate of multicomponent fibers and cellulosic sponge particles into the forming chamber to produce a deposited fibrous mat of total basis weight of approximately 1000 gsm. The fibers and particles were deposited generally uniformly onto the SCOTCH-BRITE/Texiron D38 stack. A (partial) vacuum was applied to the underside of the porous endless belt to assist in the deposition.

The SCOTCH-BRITE/Texiron D38 stack with particle-containing fibrous mat thereupon was then passed through two heating units in succession (two units were used because of the relatively small size and heating capacity of the units available). The first heating unit was an oven containing flowing air at a temperature of approximately 160° C. The residence time of the stack in the first heating unit was approximately five minutes. The second heating unit was an oven containing flowing air at a temperature of approximately 170° C. The second oven also contained endless belts (comprised of a netting), through which the SCOTCH-BRITE/Texiron D38 stack with particle-containing fibrous mat thereupon was passed two times in succession. The gap between the belts was set at approximately 15 mm on the first pass and approximately 13 mm on the second pass, such that slight pressure was applied to the stack during each pass. The residence time of the stack during each pass through the second heating unit was approximately one to two minutes.

The elevated temperature exposures served to melt-bond the particle-containing fibrous mat into a coherent web with absorbent particles bonded therein, and to bond the coherent web to the SCOTCH-BRITE.

Numerous experiments of this type were conducted. Some experiments were conducted similar to the above but using Texiron D38-50, which differed from D38-30 in having a basis weight of approximately 50 gsm.

Porous multilayer articles produced in this manner comprised an absorbent nonwoven layer of approximately 13 mm in thickness (containing chopped cellulosic sponge absorbent particles), firmly attached to a SCOTCH-BRITE nonwoven layer of approximately 7 mm in thickness (containing abrasive particles).

What is claimed is:

1. A method of making a porous multilayer web, comprising:
introducing discontinuous multicomponent polymeric fibers into a forming chamber;
introducing particles into the forming chamber;
mixing the multicomponent fibers and particles within the forming chamber;
depositing the multicomponent fibers and particles onto a first porous web to form a porous, particle-containing fibrous mat atop the first porous web; and,
exposing the porous, particle-containing fibrous mat to an elevated temperature to melt-bond at least some of the multicomponent fibers to each other and to melt-bond at least some of the multicomponent fibers to at least some of the particles, so as to produce a particle-containing, coherent porous web,
wherein the elevated temperature also causes the particle-containing coherent porous web and the first porous web to melt-bond together to form a porous, multilayer web.

2. The process of claim 1 wherein the depositing of the multicomponent fibers and particles onto the first porous web is performed by passing the first porous web through or underneath the forming chamber and gravity-dropping the multicomponent fibers and particles onto the first porous web, and wherein the elevated temperature exposure is achieved by passing the first porous web with the fibrous mat thereupon through a heating unit that is separate from the forming chamber.

3. The method of claim 1 including providing a heat-activatable porous web having at least a first major surface and a second major surface in overlapping relation with at least a portion of the first porous web, depositing the multicomponent fibers and particles onto the first major surface of the heat-activatable porous web, and bringing the second major surface of the heat-activatable porous web into contact with the first porous web, wherein the elevated temperature causes the heat-activatable porous web to be activated and to melt-bond the first and second porous webs together to form the porous, multilayer web.

4. The process of claim 3 wherein the heat-activatable web is a polymeric nonwoven web comprising fibers at least a portion of which exhibit a melting point that is within about 25 degrees C. of the melting point of a first, lower-melting portion of the multicomponent discontinuous polymeric fibers.

5. The process of claim 3 further comprising applying at least a partial vacuum to a major surface of the first porous web such that a pressure differential exists through the first porous web and through the heat-activatable web to assist the depositing of the fibers onto the first major surface of the heat-activatable web.

6. The process of claim 1 wherein the particles are selected from the group consisting of abrasive particles, metal particles, detergent particles, surfactant particles, biocide particles, adsorbent particles, absorbent particles, microcapsules, and combinations thereof.

7. The process of claim 1 wherein the particles are absorbent particles selected from the group consisting of chopped cellulosic sponge particles and chopped polyurethane sponge particles and mixtures thereof

8. The process of claim 1 wherein the discontinuous fibers are cut fibers.

9. The process of claim 1 further comprising introducing filling fibers into the forming chamber, mixing them with the multicomponent fibers, and depositing them onto the first porous web.

10. The process of claim 1 wherein the first porous web contains particles that are different from the particles deposited onto the first porous web.

11. The process of claim 1 wherein the first porous web is a polymeric fibrous web selected from the group consisting of nonwoven webs, woven webs, knitted webs, microfibrillated cloths, and plastic netting.

12. The process of claim 11 wherein the first porous web is a scouring pad comprised of a highly porous nonwoven comprising thermoplastic fibers or filaments bonded to each other at least at some points of fiber contact by a binder or melt-bonding, and further comprising abrasive particles bonded to at least some of the fibers or filaments.

13. The process of claim 1 wherein the elevated temperature exposure comprises passing the first porous web and the porous, particle-containing fibrous mat thereupon through a through-air bonder.

14. The process of claim 1 wherein the fibers and particles are mixed within the forming chamber by a plurality of rotating spike rollers.

15. The process of claim 1 further comprising cutting the porous multilayer web completely through the thickness of the first porous web and the particle-containing coherent porous web so as to separate the porous multilayer web into a plurality of porous multilayer articles.

16. A porous multilayer article, comprising:
a first porous nonwoven layer comprising polymeric fibers and abrasive particles bonded thereto;
a second porous nonwoven layer comprising discontinuous multicomponent polymeric fibers at least some of which are melt-bonded to each other at least at some points of fiber contact, and comprising absorbent particles melt-bonded to at least some of the multicomponent fibers;
wherein the first and second porous nonwoven layers are melt-bonded to each other.

17. The article of claim 16 wherein the first and second porous nonwoven layers are directly bonded to each other by way of at least some of the multicomponent fibers of the second porous nonwoven layer being bonded to at least some of the fibers of the first porous nonwoven layer.

18. The article of claim 16 wherein the first and second nonwoven layers are indirectly bonded to each other by way of a heat-activatable porous nonwoven layer located between the first and second nonwoven layers and melt-bonded to the first nonwoven layer and the second nonwoven layer.

19. The article of claim 16 wherein the first porous nonwoven layer is a scouring pad comprising thermoplastic fibers or filaments bonded to each other at least at some points of fiber contact by a binder or melt-bonding, and further comprising abrasive particles bonded to at least some of the fibers or filaments.

20. The article of claim 16 wherein the absorbent particles are selected from the group consisting of chopped cellulosic sponge particles and chopped polyurethane sponge particles and mixtures thereof.
